(19) United States
(12) Patent Application Publication
(10) Pub. No.: US 2010/0158535 A1
(43) Pub. Date: Jun. 24, 2010

(54) SMALL FORM-FACTOR PLUGGABLE TRANSCEIVER MODULE

(75) Inventor: Huitsuo CHOU, Hsinchu County (TW)

Correspondence Address: BRIAN M. MCINNIS, 12th Floor, Ruttonjee House, 11 Duddell Street, Hong Kong, HK

(73) Assignee: Ming-Feng HO, Hsinchu County (TW)

(21) Appl. No.: 12/492,131

(22) Filed: Jun. 25, 2009

(30) Foreign Application Priority Data
Dec. 22, 2008 (TW) 97150111

(51) Int. Cl. H04B 10/00

(52) U.S. Cl. 398/135

(57) ABSTRACT

A small form-factor pluggable transceiver module including a first optical transceiver device having a first circuit board, a second optical transceiver device having a second circuit board, and a third circuit board, disposed between the first circuit board and the second circuit board, having golden fingers hot-pluggable to an electronic equipment. The first circuit board preferably parallels with the second circuit board, and the third circuit board is preferably perpendicular to the first circuit board and the second circuit board. In addition, the third circuit board is preferably higher than the bottoms of the first circuit board and the second circuit board.

### RELATED APPLICATIONS

This application claims priority to Taiwan Application Serial Number 97150111, filed Dec. 22, 2008, which is herein incorporated by reference.

### FIELD OF THE INVENTION

The present invention generally relates to a transceiver module. More particularly, this invention relates to a small form-factor pluggable transceiver module.

### BACKGROUND OF THE INVENTION

As network technology grows rapidly, optoelectronic communication technology is becoming more popular because optoelectronic communication transfers a large amount of data at a high speed. One of the critical components in optoelectronic communication is the optical transceiver module, which includes a receiver to transform a received optical signal into an electronic signal, and a transmitter to transform an electronic signal into an optical signal and to transmit the optical signal.

Networking equipment such as a hub can be equipped with optical transceiver modules as described above. Fiber channel cables can be plugged into networking equipment through the optical transceiver modules. In recent fiber channel products, Gigabit Interface Converter (GBIC) optical transceiver modules have been replaced by Small Form Factor (SFF) optical transceiver modules. In addition, the SFF optical transceiver modules are further improved to Small Form Factor Pluggable (SFP) optical transceiver modules. The SFP optical transceiver module has a more compact volume than that of the GBIC optical transceiver module and can be hot-pluggable. Thus, designers can put more optical transceiver modules in the same area of the networking equipment by using the SFP optical transceiver modules with the hot-pluggable function so that the SFP optical transceiver modules can be easily installed and replaced.

### SUMMARY OF THE INVENTION

One objective of the present invention is to provide a small form-factor pluggable transceiver module having a plurality of optoelectronic converter modules and a plurality of printed circuit boards. At least one of the printed circuit boards has golden fingers and is disposed perpendicular to the other printed circuit boards to increase the density of the communication ports of the electronic equipment, such as networking equipment, and enable the electronic equipment to contain more optical transceiver devices on the same area.

To achieve these and other advantages and in accordance with the objective of the present invention, as the embodiment broadly describes herein, the present invention provides a small form-factor pluggable transceiver module having a first optical transceiver device with a first circuit board, a second optical transceiver device with a second circuit board and a third circuit board disposed between the first circuit board and the second circuit board. The third circuit board has golden fingers for plugging into electronic equipment, such as networking equipment. The first circuit board is preferably parallel to the second circuit board, and the third circuit board is preferably perpendicular to the first circuit board and the second circuit board. The bottom of the third circuit board is preferably higher than the bottoms of the first circuit board and the second circuit board.

The first optical transceiver device includes a first optoelectronic converter module, and the second optical transceiver device includes a second optoelectronic converter module. The first optoelectronic converter module and the second optoelectronic converter module are preferably bidirectional optical sub-assemblies (BOSAs). The first circuit board includes a first portion and a second portion to form an L-shaped form, and the first portion and the second portion are respectively coupled to a transmitting end and a receiving end of one of the bi-directional optical sub-assemblies.

The small form-factor pluggable transceiver module according to the present invention can utilize L-shaped terminals, flexible flat cables or flexible printed circuit boards to electrically connect the first circuit board to the third circuit board, and electrically connect the second circuit board to the third circuit board.

The small form-factor pluggable transceiver module according to the present invention complies with the requirement of a small form-factor pluggable transceiver multisource agreement (SFP transceiver MSA) and provides two optoelectronic converter modules therein. The width of the small form-factor pluggable transceiver module is about 13.5 mm.

The small form-factor pluggable transceiver module according to the present invention can further utilize a module base and a protective case to protect the optical transceiver devices therein. The module base can further include a circuit board fixing pillar to fix the third circuit board in the module base with the fixing device. The module base can further include circuit board fixing slots to fix the first circuit board and the second circuit board.

Accordingly, the front portion of the small form-factor pluggable transceiver module according to the present invention can contain two optoelectronic converter modules, such as two BOSAs, in a standard width of a single standard SFP optoelectronic converter module so as to increase the density of the optoelectronic converter modules in the electronic equipments. The small form-factor pluggable transceiver module according to the present invention further utilizes the third circuit board with golden fingers to be disposed between the first circuit board and the second circuit board so as to increase the circuit board area without changing the external dimensions of the standard SFP optical transceiver module to effectively increase the variational capability for the circuit on the circuit board and effectively provide the hot-pluggable function for the small form-factor pluggable transceiver module.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 illustrates a preferred embodiment of a small form-factor pluggable transceiver module according to the present invention;

FIG. 2A illustrates a preferred embodiment of a circuit board configuration of the small form-factor pluggable transceiver module according to the present invention; and

FIG. 2B illustrates another preferred embodiment of a circuit board configuration of the small form-factor pluggable transceiver module according to the present invention.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

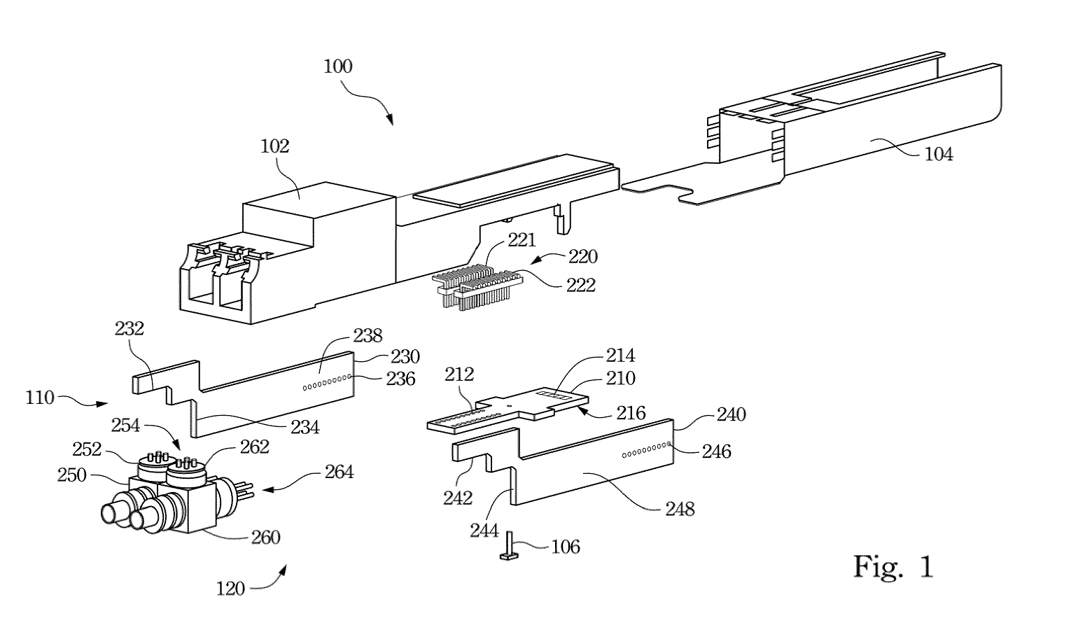

Refer to FIG.1. FIG. 1 illustrates a preferred embodiment of a small form-factor pluggable transceiver module according to the present invention. The small form-factor pluggable transceiver module 100 includes a module base 102, a protective case 104, a plurality of optical transceiver devices, such as a first optical transceiver device 110 and a second optical transceiver device 120, and a third circuit board 210 disposed therein. The first optical transceiver device 110 includes a first circuit board 230, and the second optical transceiver device 120 includes a second circuit board 240. The first circuit board 230 and the second circuit board 240 are disposed parallel to each other, and the third circuit board 210 is disposed between the first circuit board 230 and the second circuit board 240. Preferably, the third circuit board 210 is perpendicular to the first circuit board 230 and the second circuit board 240.

The third circuit board 210 has golden fingers 214 and golden fingers 216 disposed at the rear portion of the third circuit board 210 to allow the small form-factor pluggable transceiver module 100 according to the present invention to hot-plug into an electronic equipment, such as a networking equipment.

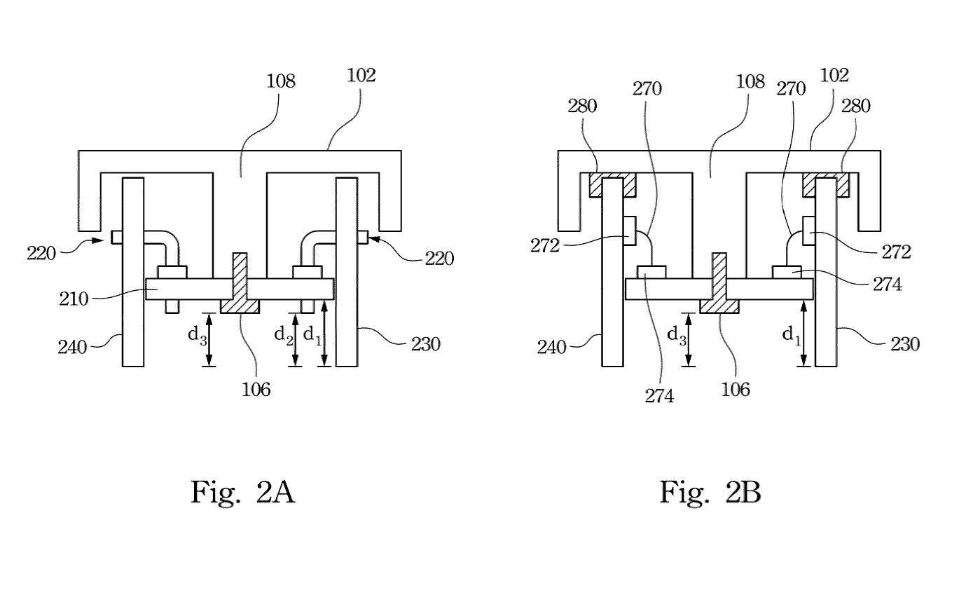

Refer to FIG. 2A and 2B. FIG. 2A and FIG. 2B illustrate preferred embodiments of the circuit board configuration of the small form-factor pluggable transceiver module according to the present invention. In FIG. 1 and FIG. 2A, the third circuit board 210 is coupled to the first circuit board 230 with L-shaped terminals 220. The first circuit board 230 includes through holes 236, and the third circuit board 210 includes through holes 212. The first terminals 221 of the L-shaped terminals 220 respectively pass through the through holes 236 of the first circuit board 230 and the through holes 212 of the third circuit board 210 to electrically connect the first circuit board 230 and the third circuit board 210. Because the additional third circuit board 210 is disposed between the first circuit board 230 and the second circuit board 240, the small form-factor pluggable transceiver module according to the present invention has an extended circuit board area to allow increasing the circuit variation for the small form-factor pluggable transceiver module. In addition, the small form-factor pluggable transceiver module can easily hot-plug with the electronic equipment with the golden fingers 214 and the golden fingers 216 on the third circuit board 210.

In FIG. 2B, the third circuit board 210 is electrically connected to the first circuit board 230 with a flexible printed circuit board 270, or a flexible flat cable. The first circuit board 230 includes a connector 272, and the third circuit board 210 includes a connector 274. The flexible printed circuit board 270 is connected to the connector 272 and the connector 274 to electrically connect the first circuit board 230 to the third circuit board 210. Similarly, due to the additional third circuit board 210, the small form-factor pluggable transceiver module according to the present invention has an extended circuit board area to allow increasing the circuit variation for the small form-factor pluggable transceiver module. In addition, the small form-factor pluggable transceiver module can easily hot-plug with the electronic equipment with the golden fingers 214 and the golden fingers 216 on the third circuit board 210.

Referring back to FIG. 2A, the L-shaped terminals 220 can also couple the third circuit board 210 to the first circuit board 230 under the third circuit board 210. That is to say, one end of the L-shaped terminal 220 upwardly passes through the third circuit board 210, another end of the L-shaped terminal-220 passes through the first circuit board 230 to electrically connect the first circuit board 230 to the third circuit board 210. Similarly, the connector 274 can be disposed on the bottom surface of the third circuit board 210 to electrically connect to the connector 272 of the first circuit board 230 with the flexible printed circuit board 270.

The third circuit board 210 is disposed between the first circuit board 230 and the second circuit board 240, and preferably, the third circuit board 210 does not protrude over the bottom edges of the first circuit board 230 and the second circuit board 240. That is to say, the bottom surface of the third circuit board 210 is higher than the bottom of the first circuit board 230 around a distance d1. In addition, the bottom of the fixing device 106 is higher than the bottom of the first circuit board 230 around a distance d3. Furthermore, the bottom of the L-shaped terminals 220 is higher than the bottom of the first circuit board 230 around a distance d2. Therefore, the third circuit board 210 does not increase the volume of the small form-factor pluggable transceiver module 100 and can easily hot-plug with the electronic equipment.

Moreover, the front portion of the first circuit board 230 is formed an L-shaped form with a first portion 234 and a second portion 232 to respectively couple to a transmitting end 254 and a receiving end 252 of the first optoelectronic converter module 250 to transmit and receive the optical signals. The rear portion of the first circuit board 230 is a base portion 238 and the through holes 236 are formed thereon to couple to the L-shaped terminals 220. The positions of the transmitting end 254 and the receiving end 252 of the first optoelectronic converter module 250 can be switched without departing from the spirit and scope of the present invention. In addition, the width of the third circuit board 210 near the through holes 212 is preferably smaller than the width of the third circuit board 210 near the golden fingers 216 to allow the width of the third circuit board 210 near the golden fingers 216 complying with the requirement of the small form-factor pluggable transceiver multisource agreement (SFP transceiver MSA). In addition, the external dimensions of the small form-factor pluggable transceiver module 100 comply with the requirement of the SFP transceiver MSA. In addition, at the front portion of the small form-factor pluggable transceiver module 100, two optoelectronic converter module can be contained. Therefore, the first optoelectronic converter module 250 and the second optoelectronic converter module 260 can be respectively configured in the first optical transceiver device 110 and the second optical transceiver device 120 to allow the two optical transceiver devices disposing in a width for a single standard SFP optical transceiver device so as to increase the density of the optical transceiver devices in the electronic equipment.

The first optoelectronic converter module 250 can be a bidirectional optical sub-assembly (BOSA) and the second optoelectronic converter module 260 can also be a bidirectional optical sub-assembly (BOSA). Therefore, the first optoelectronic converter module 250 and the second optoelectronic converter module 260 can both receive and transmit the optical signals. Accordingly, the small form-factor pluggable transceiver module 100 according to the present invention can contain two independent BOSA to comply with a standard width of the SFP-MSA requirement. Therefore, the total width of the first optical transceiver device 110 with the hot-pluggable function and the second optical transceiver device 120 with the hot-pluggable function is about 13.5 mm.

Similarly, in FIG. 1 and FIG. 2A, the third circuit board 210 is electrically connected to the second circuit board 240 with the L-shaped terminals 220. The second circuit board 240 includes through holes 246, and the third circuit board 210 includes through holes 212. The second terminals 222 of the L-shaped terminals 220 respectively pass through the through holes 246 of the second circuit board 240 and the through holes 212 of the third circuit board 210 to electrically connecting the second circuit board 240 to the third circuit board 210.

In FIG. 2B, the third circuit board 210 is electrically connected to the second circuit board 240 with the flexible printed circuit board 270. The second circuit board 240 includes a connector 272, and the third circuit board 210 includes a connector 274. The flexible printed circuit board 270 is connected to the connector 272 and a connector 274.to electrically connect the second circuit board 240 to the third circuit board 210.

The L-shaped terminals 220 can also couple the third circuit board 210 to the second circuit board 240 under the third circuit board 210. Similarly, the connector 274 can be also disposed on the bottom surface of the third circuit board 210 to electrically connect to the connector 272 of the second circuit board 240 with the flexible printed circuit board 270.

The module base 102 preferably includes a circuit board fixing pillar 108 to fix the third circuit board 210 in the module base 102 with a fixing device 106. Alternatively, the module base 102 preferably includes circuit board fixing slots 280 to conveniently fix the first circuit board 230 and the second circuit board 240 in the module base 102. Furthermore, the module base 102 preferably includes a circuit board fixing pillar 108 to fix the third circuit board 210 in the module base 102 with a fixing device 106, and circuit board fixing slots 280 to conveniently fix the first circuit board 230 and the second circuit board 240 in the module base 102.

Accordingly, the front portion of the small form-factor pluggable transceiver module according to the present invention can contain two optoelectronic converter modules, such as two BOSAs, in a standard width of a single standard SFP optoelectronic converter module to increase the density of the optoelectronic converter modules in the electronic equipments. The small form-factor pluggable transceiver module according to the present invention further utilizes the golden fingers of the third circuit board disposed between the first circuit board and the second circuit board to increase the circuit board area without changing the external dimensions of a single standard SFP optical transceiver module so as to increase the variational capability for the circuit on the circuit board and provide the hot-pluggable function for the small form-factor pluggable transceiver module.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A small form-factor pluggable transceiver module, comprising:
a first optical transceiver device having a first circuit board;
a second optical transceiver device having a second circuit board parallel to the first circuit board; and
a third circuit board disposed between the first circuit board and the second circuit board, wherein the third circuit board comprises golden fingers for plugging in an electronic equipment.

2. The small form-factor pluggable transceiver module of claim 1, wherein the first optical transceiver device comprises a first optoelectronic converter module, and the second optical transceiver device comprises a second optoelectronic converter module.

3. The small form-factor pluggable transceiver module of claim 2, wherein the first optoelectronic converter module and the second optoelectronic converter module are bidirectional optical sub-assemblies (BOSAs).

4. The small form-factor pluggable transceiver module of claim 3, wherein the first circuit board comprises a first portion and a second portion to form an L-shaped form, and the first portion and the second portion are respectively coupled to a transmitting end and a receiving end of one of the bidirectional optical sub-assemblies.

5. The small form-factor pluggable transceiver module of claim 1, wherein the third circuit board is perpendicular to the first circuit board and the second circuit board.

6. The small form-factor pluggable transceiver module of claim 1, further comprising L-shaped terminals to electrically connect the first circuit board to the third circuit board, and electrically connect the second circuit board to the third circuit board.

7. The small form-factor pluggable transceiver module of claim 1, further comprising flexible flat cables or flexible printed circuit boards to electrically connect the first circuit board to the third circuit board and electrically connect the second circuit board to the third circuit board.

8. The small form-factor pluggable transceiver module of claim 1, wherein external dimensions of the small form-factor pluggable transceiver module comply with a requirement of a small form-factor pluggable transceiver multisource agreement (SFP transceiver MSA).

9. The small form-factor pluggable transceiver module of claim 1, wherein a width of the small form-factor pluggable transceiver module is about 13.5 mm.

10. The small form-factor pluggable transceiver module of claim 1, wherein a bottom of the third circuit board is higher than bottoms of the first circuit board and the second circuit board.

11. A small form-factor pluggable transceiver module, comprising:
a module base;
a protective case;
a first optical transceiver device disposed in the module base and the protective case, the first optical transceiver device having a first circuit board;
a second optical transceiver device disposed in the module base and the protective case, the second optical transceiver device having a second circuit board parallel to the first circuit board;
a third circuit board disposed in the module base and the protective case, and disposed between the first circuit board and the second circuit board, wherein the third circuit board comprises golden fingers for hot-plugging in an electronic equipment; and
a fixing device fixing the third circuit board in the module base.

12. The small form-factor pluggable transceiver module of claim 11, wherein the module base further comprises a circuit board fixing pillar to fix the third circuit board in the module base with the fixing device.

13. The small form-factor pluggable transceiver module of claim 11, wherein the module base further comprises circuit board fixing slots to fix the first circuit board and the second circuit board.

14. The small form-factor pluggable transceiver module of claim 11, wherein the first optical transceiver device comprises a first optoelectronic converter module and the second optical transceiver device comprises a second optoelectronic converter module, and the first optoelectronic converter module and the second optoelectronic converter module are bidirectional optical sub-assemblies (BOSAs).

15. The small form-factor pluggable transceiver module of claim 14 wherein the first circuit board comprises a first portion and a second portion to form an L-shaped form, and the first portion and the second portion are respectively coupled to a transmitting end and a receiving end of one of the bidirectional optical sub-assemblies.

16. The small form-factor pluggable transceiver module of claim 11, further comprising L-shaped terminals to electrically connect the first circuit board to the third circuit board, and electrically connect the second circuit board to the third circuit board.

17. The small form-factor pluggable transceiver module of claim 11, further comprising flexible flat cables or flexible printed circuit boards to electrically connect the first circuit board to the third circuit board and electrically connect the second circuit board to the third circuit board.

18. The small form-factor pluggable transceiver module of claim 11, wherein external dimensions of the small form-factor pluggable transceiver module comply with a requirement of a small form-factor pluggable transceiver multisource agreement (SFP transceiver MSA).

19. The small form-factor pluggable transceiver module of claim 11, wherein a width of the small form-factor pluggable transceiver module is about 13.5 mm.

20. The small form-factor pluggable transceiver module of claim 11, wherein a bottom of the third circuit board is higher than bottoms of the first circuit board and the second circuit board.
